(19) United States
(12) Patent Application Publication
(10) Pub. No.: US 2015/0228960 A1
(43) Pub. Date: Aug. 13, 2015

(54) BATTERY PACK

(71) Applicant: SAMSUNG SDI CO., LTD., Yongin-si (KR)

(72) Inventors: Han-Jun WANG, Yongin-si (KR); Dae-Yon MOON, Yongin-si (KR)

(21) Appl. No.: 14/337,366

(22) Filed: Jul. 22, 2014

(30) Foreign Application Priority Data
Feb. 11, 2014 (KR) 10-2014-0015642

(51) Int. Cl. H01M 2/34; H01M 2/10; H01M 10/48; H01M 2/14; H01M 2/02

(52) U.S. Cl. CPC H01M 2/34; H01M 2/14; H01M 2/0202; H01M 10/486; H01M 2/1022; H01M 2200/00; H01M 2220/30

(57) ABSTRACT

A battery pack includes a plurality of battery units located side by side along a first direction, each battery unit of the plurality of battery units having an upper portion on which an electrode pin is located, a protective circuit module located on and electrically connected to each of the battery units, and a spacer including a first portion between adjacent battery units among the battery units and a second portion that extends from the first portion to the protective circuit module, the second portion being in a space between the adjacent battery units and the protective circuit module.

### CROSS-REFERENCE TO RELATED APPLICATION

Korean Patent Application No. 10-2014-0015642, filed on Feb. 11, 2014, in the Korean Intellectual Property Office, and entitled: “Battery Pack,” is incorporated by reference herein in its entirety.

### BACKGROUND

1. Field

One or more embodiments relate to a battery pack.

2. Description of the Related Art

Use of portable computers that operate based on internal power supplied from batteries has dramatically increased due to the development of wireless communication technologies such as the Internet. In general, since the portable computers are small and easy to carry, that is, they have high mobility, the portable computers are widely used for business or personal purposes in various places. As the portable computers include battery packs, they may be used irrespective of the area of use and connection to land power sources. A battery pack may have a plurality of battery units that may be repeatedly charged/discharged so as to provide sufficient output.

### SUMMARY

Embodiments are directed to a battery pack including a plurality of battery units located side by side along a first direction, each battery unit of the plurality of battery units having an upper portion on which an electrode pin is located, a protective circuit module located on and electrically connected to each of the battery units, and a spacer including a first portion between adjacent battery units among the battery units and a second portion that extends from the first portion to the protective circuit module, the second portion being in a space between the adjacent battery units and the protective circuit module.

The second portion of the spacer may extend along a direction that is substantially perpendicular to a length direction of the first portion of the spacer.

The second portion of the spacer may contact a top surface of at least one of the adjacent battery units and may contact a bottom surface of the protective circuit module.

Each of the plurality of battery units may include a can having an opening therein, an electrode assembly that is accommodated in the can through the opening, the electrode assembly including a first electrode plate having a first polarity, a second electrode plate having a second polarity, the second polarity being different from the first polarity, and a separator interposed between the first and second electrode plates, and a cap plate that seals the opening. The electrode pin may extend from the cap plate in an upward direction.

The electrode pin may have the first polarity. The cap plate may have the second polarity.

Each of the plurality of battery units may include a holder including a temperature-sensing element that is electrically connected to the electrode pin.

A height of the second portion of the spacer may be substantially the same as a height of the holder.

Each of the plurality of battery units may include a first electrode tab on the upper portion of the battery unit and a second electrode tab that is electrically connected to the temperature-sensing element. The first and second electrode tabs may directly contact the protective circuit module.

The battery pack may further include a case that accommodates the battery units, the protective circuit module, and the spacer.

The spacer may be fixed to the case.

Embodiments are also directed to a battery pack including a plurality of battery units, each including a top surface having a first polarity and an electrode pin having a second polarity that is different from the first polarity, a protective circuit module that is located on and electrically connected to each of the battery units, and a spacer between adjacent battery units among the battery units, the spacer extending to the protective circuit module such that one end of the spacer supports a bottom surface of the protective circuit module.

The spacer may include a first portion between the adjacent battery units, and a second portion that contacts and supports the bottom surface of the protective circuit module.

The first portion of the spacer and the second portion of the spacer may be perpendicular to each other.

The second portion of the spacer may contact the top surface of at least one of the adjacent battery units and contacts the bottom surface of the protective circuit module.

The first portion and the second portion of the spacer may constitute a “T” shape.

Each of the plurality of battery units may include a can having an opening therein, the can being formed of a metal material, an electrode assembly that is accommodated in the can through the opening, the electrode assembly including a first electrode plate having the first polarity, a second electrode plate having the second polarity, and a separator between the first and second electrode plates, and a cap plate that seals the opening and forms the top surface of each battery unit. The electrode pin may extend from the cap plate in an upward direction.

Each of the battery units may include a holder including a temperature-sensing element that is electrically connected to the electrode pin.

The holder may be between the top surface of each battery unit and the bottom surface of the protective circuit module.

The battery pack may further include a case that accommodates the battery units, the protective circuit module, and the spacer.

The spacer may be fixed to the case.

### BRIEF DESCRIPTION OF THE DRAWINGS

Features will become apparent to those of skill in the art by describing in detail exemplary embodiments with reference to the attached drawings in which:

FIG. 1 illustrates a schematic perspective view of a battery pack according to an embodiment;

FIG. 2 illustrates a partial exploded perspective view of each of a plurality of battery units and a holder illustrated in FIG. 1;

FIG. 3 illustrates a schematic front view of the battery pack of FIG. 1;

FIG. 4 illustrates a partial front view of a portion IV of FIG. 3; and

FIG. 5 illustrates a schematic perspective view of a battery pack according to another embodiment.

FIG. 6 illustrates a cross-sectional view taken along a line VI-VI of FIG. 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

As used herein, the singular forms “a”, “an”, and “the” are intended to include the plural forms as well, unless the context clearly indicates otherwise.

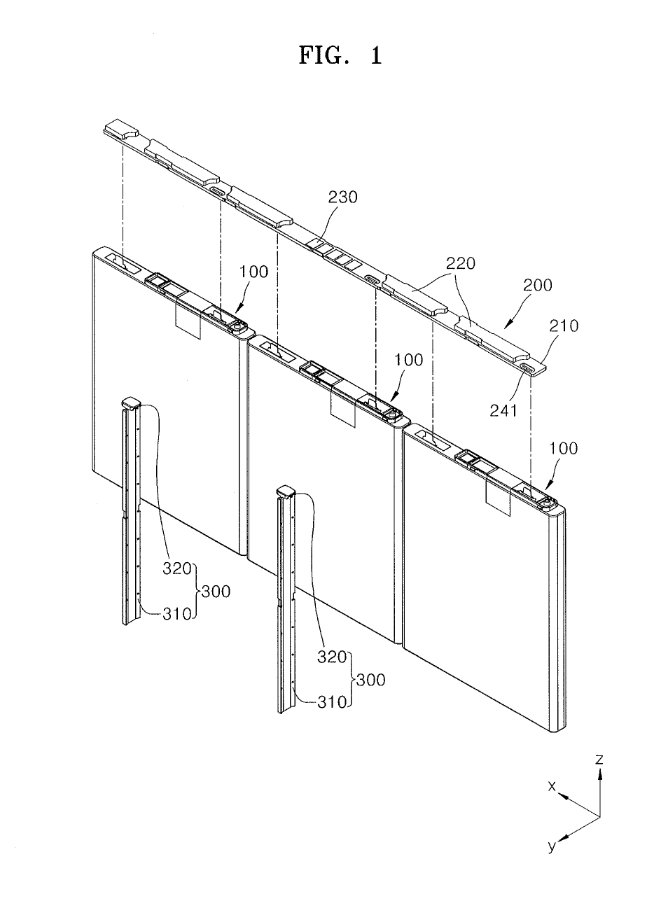

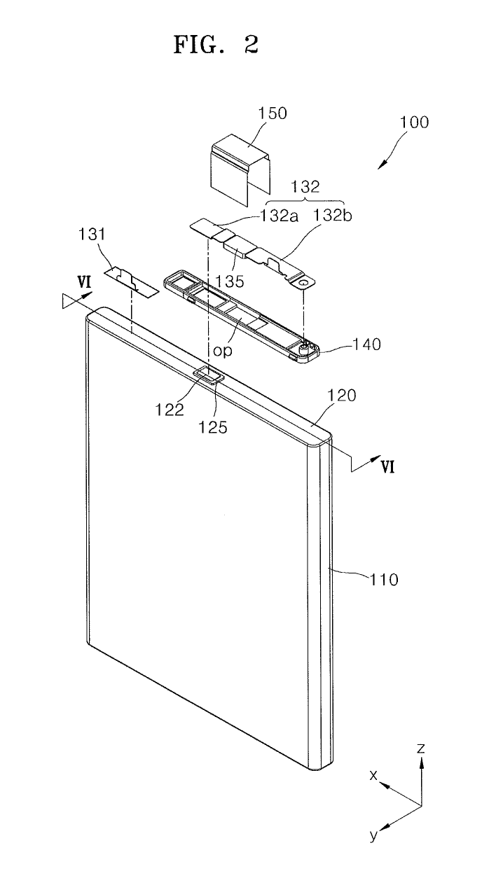

FIG. 1 illustrates a schematic perspective view of a battery pack according to an embodiment, and FIG. 2 illustrates a partial perspective view of each of a plurality of battery units 100 illustrated in FIG. 1.

Referring to FIG. 1, the battery pack according to the current embodiment may include the plurality of battery units 100, a protective circuit module 200 that is electrically connected to each of the plurality of battery units 100, and a spacer 300 that electrically insulates the battery units 100 from each other.

The plurality of battery units 100 may be disposed side by side along a first direction. For example, the plurality of battery units 100 may be disposed side by side so that their top surfaces are in the same direction. Sides of adjacent battery units 100 may face each other. Each of the battery units 100 may be a lithium-ion battery, that is, a secondary battery that may be recharged.

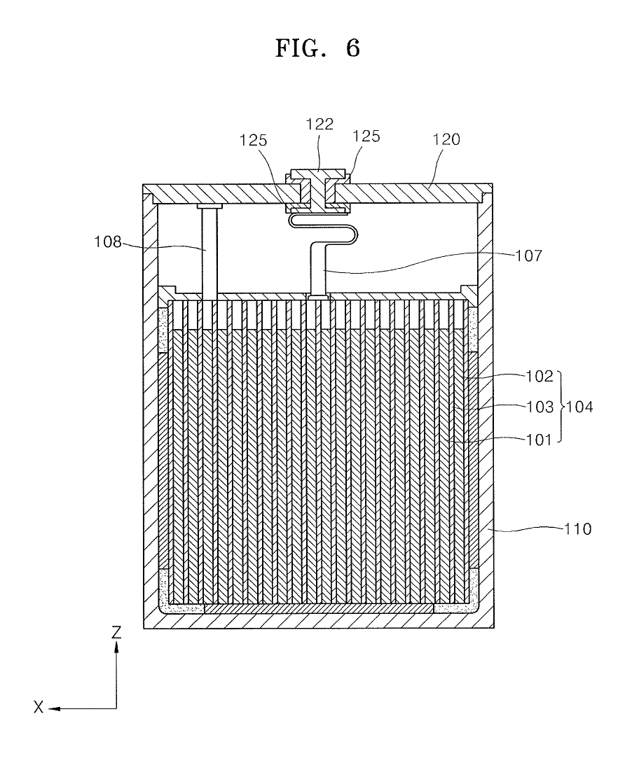

Referring to FIGS. 2 and 6, each of the battery units 100 may include a can 110 having an opening formed therein, an electrode assembly 104 accommodated in the can 110 through the opening, a cap plate 120 that seals the opening of the can 110, an electrode pin 122 formed on the cap plate 120, a holder 140 placed on the cap plate 120, and first and second electrode tabs 131 and 132.

The can 110 may have an opened, approximately hexahedral top surface and may be manufactured of a metallic material so as have suitable resistance. For example, the can 110 may be manufactured of aluminum (Al) or an Al alloy. After the electrode assembly 104 is inserted into the can 110 through the opening, the opening may be sealed by the cap plate 120. The cap plate 120 may be manufactured of a metallic material, such as Al or an Al alloy, like the can 110. Portions where the cap plate 120 and the can 110 contact each other may be combined with each other through laser welding such that an internal air-tight state may be maintained.

The electrode assembly 104 may include a first electrode plate 101 and a second electrode plate 102 onto which an electrode active material is coated, and a separator 103 interposed therebetween. The first electrode plate 101 and the second electrode plate 102 may have different polarities. The electrode assembly 104 may be manufactured in such a way that the first electrode plate, the separator 103, and the second electrode plate 102 are sequentially stacked on the electrode assembly 104 and may wound in a jelly roll shape.

In the current embodiment, the electrode assembly 104 has a jelly roll shape. In other implementations, the electrode assembly 104 may be a stack structure in which the first electrode plate, the separator 103, and the second electrode plate 102 are sequentially stacked.

The electrode pin 122 may be formed on the cap plate 120. The first electrode plate 101 may be electrically connected to the electrode pin 122 via a lead 107, and the second electrode plate 102 may be electrically connected to the cap plate 120 via a lead 108. The first electrode plate 101 and the second electrode plate 102 may have different polarities. Accordingly, the electrode pin 122 and the cap plate 120 may have different polarities. For example, the electrode pin 122 may have a negative electrode polarity, and the cap plate 120 may have a positive electrode polarity. A gasket 125 may be provided between the electrode pin 122 and the cap plate 120 so as to prevent a short circuit between the electrode pin 122 and the cap plate 120. The gasket 125 may be manufactured of an insulating material and may prevent an electrical short circuit between the electrode pin 122 and the cap plate 120.

The battery unit 100 may include the first and second electrode tabs 131 and 132. The first and second electrode tabs 131 and 132 may serve as a positive electrode terminal and a negative electrode terminal of a secondary battery.

For example, the first electrode tab 131 may be disposed on the cap plate 120 and may be electrically connected to the cap plate 120. When the cap plate 120 has a positive electrode polarity, the first electrode tab 131 welded onto the cap plate 120 may also have a positive electrode polarity.

The second electrode tab 132 may be connected to the electrode pin 122 and a temperature-sensing element 135, such as a temperature cutoff (TCO). For example, the second electrode tab 132 may include a first portion 132a and a second portion 132b. One end of the first portion 132a may be connected to the electrode pin 122, and the other end of the first portion 132a may be connected to the temperature-sensing element 135. One end of the second portion 132b may be connected to the temperature-sensing element 135 such that the second electrode tab 132 including the temperature-sensing element 135 may be electrically connected to the electrode pin 122.

The first and second electrode tabs 131 and 132 may be disposed on the cap plate 120.

The cap plate 120 may have a positive electrode polarity, as described above. Accordingly, if the holder 140, described below, were not present, an electrical short circuit could easily occur between the cap plate 120 and the second electrode tab 132 having a negative electrode polarity. Thus, the second electrode tab 132 may be disposed on the holder 140 put on the cap plate 120.

The holder 140 may accommodate the second electrode tab 132 and the temperature-sensing element 135. The holder 140 may include an opening op formed in a position corresponding to a position of the temperature-sensing element 135 such that the temperature-sensing element may sensitively react to a change in temperature of the battery unit 100.

The holder 140 may be fixed onto the battery unit 100 using a fixing member, such as a tape 150, while accommodating the second electrode tab 132 and the temperature-sensing element 135.

Referring back to FIG. 1, the protective circuit module 200 may be disposed on each battery unit 100 and may be electrically connected to each battery unit 100 such that charging/discharging of each battery unit 100 may be controlled. The protective circuit module 200 may prevent overheating and/or explosion that could occur due to overcharging, overdischarging or overcurrent of the battery unit 100.

The protective circuit module 200 may include circuit boards 210, protective elements 220 mounted on the circuit boards 210, and external terminals 230. The circuit boards 210 may extend along an arrangement direction of the plurality of battery units 100, and the protective elements 220 may be safety elements including passive elements, such as resistors and capacitors of the circuit boards 210, or active elements, such as field effect transistors (FETs), and integrated circuits (ICs).

Each of the circuit boards 210 may include a connection hole 241. The first and second electrode tabs 131 and 132 provided on each of the battery units 100 may be inserted into the connection hole 241 formed in each circuit board 210 and the first and second electrode tabs 131 and 132 and the circuit board 210 may be soldered together. Patterns through which the battery units 100 may be connected in series and/or in parallel, may be formed on the circuit board 210. The first and second electrode tabs 131 and 132 of each battery unit 100 may be directly connected to the connection hole 241 formed in the circuit board 210 such that the plurality of battery units 100 may be charge/discharge-controlled according to driving of the protective elements 220 and simultaneously may be connected in series and/or in parallel.

The spacer 300 may be interposed between adjacent battery units 100. One end of the spacer 300 may extend toward the protective circuit module 200 so as to support the protective circuit module 200. For example, the spacer 300 may include a first portion 310 interposed between the adjacent battery units 100, and a second portion 320 that extends from the first portion 310 to the protective circuit module 200.

The first portion 310 of the spacer 300 may electrically insulate the adjacent battery units 100 from each other. As described previously with reference to FIG. 2, the can 110 and the cap plate 120 of the battery unit 100 may be manufactured of a metallic material, and the can 110 may be welded to the cap plate 120 such that the can 110 may have the same polarity as that of the cap plate 120. When the battery units 100 are disposed side by side, as illustrated in FIG. 1, if the spacer 300 were not present, an undesired electrical connection between the adjacent battery units 100 could be formed. However, in an embodiment, the first portion 310 of the spacer 300 is interposed between the adjacent battery units 100. Accordingly an undesired electrical connection between the adjacent battery units 100 may be prevented.

The second portion 320 of the spacer 300 may be interposed in a space (or a gap) between the protective circuit module 200 and the battery unit 100 and may support the protective circuit module 200. The battery unit 100 may include the electrode pin 122 that protrudes in an upward direction and the holder 140 may be interposed on the battery unit 100. Accordingly a space may be formed between the top surface of the battery unit 100 and a bottom surface of the protective circuit module 200. When the second portion 320 of the spacer 300 is interposed in the space, the protective circuit module 200 may be supported and simultaneously may be protected from an external force applied to the protective circuit module 200.

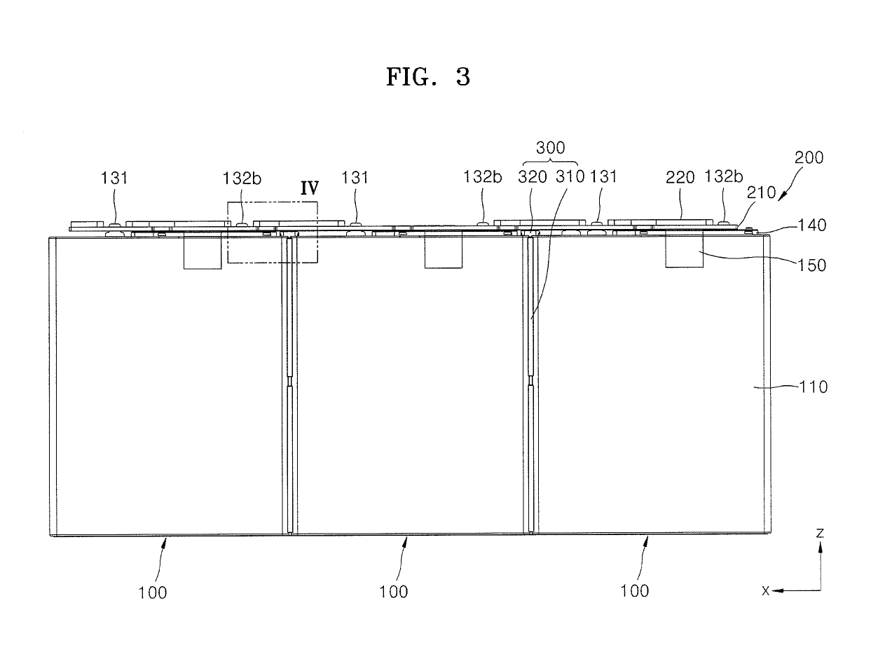

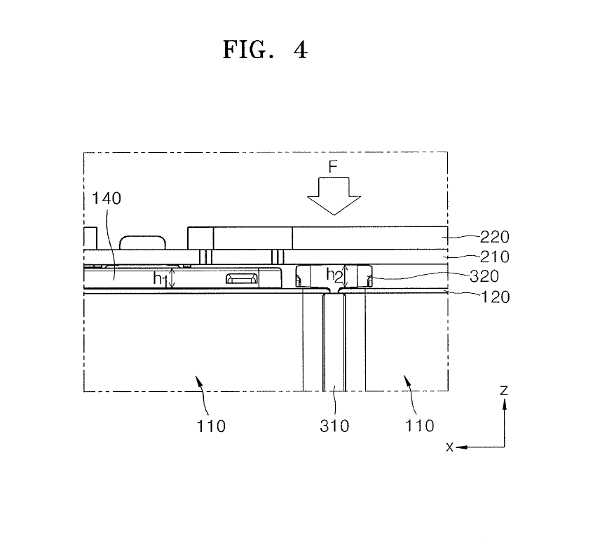

A function and a detailed structure of the spacer 300 will now be described with reference to FIGS. 3 and 4.

FIG. 3 illustrates a schematic front view of the battery pack of FIG. 1, and FIG. 4 illustrates a partial front view of a portion IV of FIG. 3.

Referring to FIGS. 3 and 4, the spacer 300 may include the first portion 310 that extends along a height direction of the battery unit 100 and the second portion 320 that extends along a direction that is substantially perpendicular to a length direction of the first portion 310. For example, the first portion 310 and the second portion 320 may constitute a “T” shape.

The second portion 320 of the spacer 300 may contact top surfaces of the adjacent battery units 100 and the bottom surface of the protective circuit module 200. For example, a bottom surface of the second portion 320 of the spacer 300 may contact the top surface of the battery unit 100 disposed at one side of the spacer 300 and the top surface of the battery unit 100 disposed at the other side of the spacer 300, and a top surface of the second portion 320 of the spacer 300 may contact the bottom surface of the protective circuit module 200.

In the current embodiment, the spacer 300 constitutes the “T” shape. In other implementations, the spacer 300 may constitute a “ [symbol] ” shape (for example, an L shape rotated 90°. In this case, the second portion 320 of the spacer 300 may contact only one of the top surfaces of the adjacent battery units 100 and the bottom surface of the protective circuit module 200.

A height h2 of the second portion 320 of the spacer 300 may be substantially the same as a height h1 of the holder 140 placed on the battery unit 100. The second portion 320 of the spacer 300 having substantially the same height as that of the holder 140 may support the bottom surface of the protective circuit module 200 that is not supported by the holder 140 and may prevent assembly characteristics of the battery pack from being lowered. For example, the second portion 320 of the spacer 300 may prevent or reduce the likelihood of twisting of or damage to the protective circuit module 200.

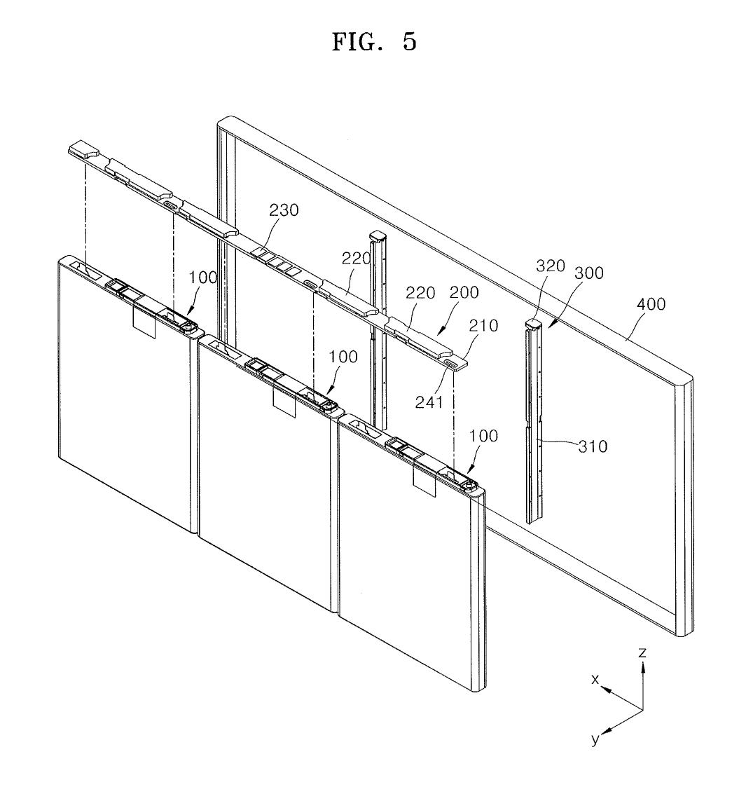

FIG. 5 illustrates a schematic perspective view of a battery pack according to another embodiment.

Referring to FIG. 5, a spacer 300 of the battery pack according to the current embodiment may be fixed to a case 400. For example, the spacer 300 may be fixed to the case 400 using an adhesive or may be injection molded integrally with the case 400 and thus fixed to the case 400.

A plurality of battery units 100 and a protective circuit module 200 may be accommodated in the case 400 to which the spacer 300 is fixed, and a top surface of the case 400 exposed to the outside may be covered with an insulating label (not shown) or may be covered by an upper case (not shown) that is coupled to the case 400.

As described above, according to the one or more of the above embodiments, assembly characteristics of a battery pack may be enhanced.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A battery pack, comprising:
a plurality of battery units located side by side along a first direction, each battery unit of the plurality of battery units having an upper portion on which an electrode pin is located;
a protective circuit module located on and electrically connected to each of the battery units; and
a spacer including a first portion between adjacent battery units among the battery units and a second portion that extends from the first portion to the protective circuit module, the second portion being in a space between the adjacent battery units and the protective circuit module.

2. The battery pack as claimed in claim 1, wherein the second portion of the spacer extends along a direction that is substantially perpendicular to a length direction of the first portion of the spacer.

3. The battery pack as claimed in claim 1, wherein the second portion of the spacer contacts a top surface of at least one of the adjacent battery units and contacts a bottom surface of the protective circuit module.

4. The battery pack as claimed in claim 1, wherein each of the plurality of battery units includes:
a can having an opening therein;
an electrode assembly that is accommodated in the can through the opening, the electrode assembly including a first electrode plate having a first polarity, a second electrode plate having a second polarity, the second polarity being different from the first polarity, and a separator interposed between the first and second electrode plates; and
a cap plate that seals the opening,
wherein the electrode pin extends from the cap plate in an upward direction.

5. The battery pack as claimed in claim 4, wherein:
the electrode pin has the first polarity, and
the cap plate has the second polarity.

6. The battery pack as claimed in claim 1, wherein each of the plurality of battery units includes a holder including a temperature-sensing element that is electrically connected to the electrode pin.

7. The battery pack as claimed in claim 6, wherein a height of the second portion of the spacer is substantially the same as a height of the holder.

8. The battery pack as claimed in claim 6, wherein:
each of the plurality of battery units includes a first electrode tab on the upper portion of the battery unit and a second electrode tab that is electrically connected to the temperature-sensing element, and
the first and second electrode tabs directly contact the protective circuit module.

9. The battery pack as claimed in claim 1, further comprising a case that accommodates the battery units, the protective circuit module, and the spacer.

10. The battery pack as claimed in claim 9, wherein the spacer is fixed to the case.

11. A battery pack, comprising:
a plurality of battery units, each including a top surface having a first polarity and an electrode pin having a second polarity that is different from the first polarity;
a protective circuit module that is located on and electrically connected to each of the battery units; and
a spacer between adjacent battery units among the battery units, the spacer extending to the protective circuit module such that one end of the spacer supports a bottom surface of the protective circuit module.

12. The battery pack as claimed in claim 11, wherein the spacer includes:
a first portion between the adjacent battery units; and
a second portion that contacts and supports the bottom surface of the protective circuit module.

13. The battery pack as claimed in claim 12, wherein the first portion of the spacer and the second portion of the spacer are perpendicular to each other.

14. The battery pack as claimed in claim 12, wherein the second portion of the spacer contacts a top surface of at least one of the adjacent battery units and contacts the bottom surface of the protective circuit module.

15. The battery pack as claimed in claim 12, wherein the first portion and the second portion of the spacer constitute a “T” shape.

16. The battery pack as claimed in claim 11, wherein each of the plurality of battery units includes:
a can having an opening therein, the can being formed of a metal material;
an electrode assembly that is accommodated in the can through the opening, the electrode assembly including a first electrode plate having the first polarity, a second electrode plate having the second polarity, and a separator between the first and second electrode plates; and
a cap plate that seals the opening and forms the top surface of each battery unit, wherein the electrode pin extends from the cap plate in an upward direction.

17. The battery pack as claimed in claim 11, wherein each of the battery units includes a holder including a temperature-sensing element that is electrically connected to the electrode pin.

18. The battery pack as claimed in claim 17, wherein the holder is between the top surface of each battery unit and the bottom surface of the protective circuit module.

19. The battery pack as claimed in claim 12, further comprising a case that accommodates the battery units, the protective circuit module, and the spacer.

20. The battery pack as claimed in claim 19, wherein the spacer is fixed to the case.
